(19) United States
(12) Patent Application Publication
(10) Pub. No.: US 2026/0073815 A1
(43) Pub. Date: Mar. 12, 2026

(54) SYSTEM FOR SELF-CATHETERIZATION TRAINING AND RELATED METHODS

(71) Applicant: REHABILITATION INSTITUTE OF CHICAGO, Chicago, IL (US)

(72) Inventors: Katherine Earnest, Chicago, IL (US); Chandler Clark, Chicago, IL (US); Douglas Zabel, Chicago, IL (US); Monica Dasgupta, Chicago, IL (US)

(73) Assignee: REHABILITATION INSTITUTE OF CHICAGO, Chicago, IL (US)

(21) Appl. No.: 19/324,989

(22) Filed: Sep. 10, 2025

Related U.S. Application Data
(60) Provisional application No. 63/692,807, filed on Sep. 10, 2024.

(51) Int. Cl. G09B 23/32

(52) U.S. Cl. CPC G09B 23/32

(57) ABSTRACT

A self-catheterization training system includes an anatomical model that can be removably attached to one or more base styles to accommodate training for both patients and their caregivers at wheelchair level, bedside or on a tabletop. In a method of self-catheterization training, the self-catheterization training system is provided, and the catheter is inserted into an anterior opening and is passed through the passage to a posterior opening.

### CROSS-REFERENCE TO RELATED APPLICATION

This application claims benefit to U.S. Provisional Application No. 63/692,807, filed Sep. 10, 2024, which is herein incorporated by reference in its entirety for all purposes.

### FIELD

Aspects of the disclosure relate generally to methods and systems for training an individual to self-catheterize.

### BACKGROUND

Intermittent Self-Catheterization (ISC) is a technique for emptying the bladder using a catheter. It involves inserting a catheter (a thin, bendable tube) in the urethra and into the bladder to allow urine to drain out. Once the urine has drained, the catheter is removed. This is repeated several times throughout the day, typically every four to six hours.

Individuals may need to learn to self-catheterize at home or in rehabilitation or hospital settings for a variety of reasons, including spinal cord injury, neurological diagnoses (e.g., multiple sclerosis, Parkinson's, etc.) and anatomical or functional problems with the bladder, urethra, or prostate (e.g., cancer affecting any of these structures, prostate enlargement, etc.). Moreover, many individuals who learn to self-catheterize are wheelchair users. In the United States, there are approximately 18,000 new cases of traumatic spinal cord injury (SCI) per year (See, e.g., https://www.nscisc.uab.edu/public/Facts%20and%20Figures%202024%20-%20Final.pdf). Approximately 60% of patients with new SCI will discharge with sufficient upper extremity function to independently perform ISC. (See https://www.nature.com/articles/sc2015169#:˜:text=In%20our%20study%2C%2058.8%25%20of,UE%20function%20to%20self%2Dcatheterize). When patients do not retain sufficient upper extremity function to perform ISC, they may opt for intermittent catheterization performed by a family member or caregiver. Seventy-nine (79) percent of new traumatic SCIs occur in men. Intermittent catheterization is typically completed at the wheelchair level for many of these individuals.

ISC can drastically improve the quality of life for affected individuals by allowing them to regain control over bladder management without the restrictions of indwelling catheters, bulky external appliances, or incontinence pads. In addition, since the bladder is being drained effectively, the frequency of urinary tract infections can also be mitigated. While ISC is safe and effective, there is a learning curve, and many people feel apprehensive or embarrassed about performing the technique. It can also feel physically uncomfortable at first until the skill is mastered.

Anatomical models for practicing catheterization are available, but have several drawbacks. Existing models, including the male and female catheter model set by 3B Scientific (https://www.3bscientific.com/us/male-female-catheter-model-set-1013743-w44634-lifeform-lf01152u,p_1057_10923.html) and the Life/form® Male and Female Catheterization Simulators (https://shop.nascohealthcare.com/products/lf00855; https://shop.nascohealthcare.com/products/lf00856? pr_prod_strat=e5_desc&pr_rec_id=f134dabc3&pr_rec_pid=4456693956663&pr_ref_pid=4456693891127&pr_seq=uniform) are quite costly, ranging from $250 up to over $1,000. For this reason, models are often shared between hospital or rehabilitation facility units, or may not be available to patients at all.

Importantly, these models are solely table-based and designed primarily as training tools for healthcare providers, not for patients who are learning to catheterize themselves. Table-based models are intended to approximate the experience of a healthcare provider or caregiver performing catheterization on a patient in bed. While patients can use table-based models for training, they are not capable of reflecting the position of the anatomy with respect to the patient. Many individuals who can benefit from learning ISC skills, including those with spinal cord injury and their caregivers, will often perform intermittent catheterization at the wheelchair level. Existing models do not, and cannot, approximate this experience. Due to their bulkiness, or other design parameters, these models are not capable of being securely positioned at or near the groin region of a patient in a wheelchair for training purposes.

Thus, a need remains for a low-cost anatomical model that approximates the experience of performing ISC skill on one's own body. Further, a need remains for a model that allows patients to practice ISC skills, whether from a wheelchair level, in bed, or in another seated position, and allows healthcare providers or caregivers to practice catheterizing patients who are seated in wheelchairs. Such a model would be useful in any setting where patients with disabilities are trained to perform self-catheterization, or where families or caregivers are trained to perform catheterization of individuals who use wheelchairs. This may include inpatient and outpatient rehabilitation settings, urology offices, and similar facilities.

It is with these observations in mind, among others, that various aspects of the present disclosure were conceived and developed.

### SUMMARY

The following presents a summary of various aspects described herein. This summary is not an extensive overview and is not intended to identify key or critical elements or to delineate the scope of the claims. The following summary merely presents some concepts in a simplified form as an introductory prelude to the more detailed description provided below.

The self-catheterization training system described herein presents an improved and novel means for allowing patients (both male and female), their caregivers, and healthcare providers to practice the mechanics of catheterization.

For patients, the improved model more closely approximates anatomical positioning and the actual experience of self-catheterization. Moreover, for patients using a wheelchair, or for those who may feel most comfortable self-catheterizing in a seated position, the improved model can be stably affixed to the seat of a chair (such as a wheelchair) to allow for both patient and caregiver ISC training. In this configuration, the model will also allow for training healthcare providers on how to perform catheterization from chair level—a skill common in a rehabilitation setting, but uncommon in other medical specialties. In the table-based configuration, the model may allow healthcare providers and patient family members to practice this skill in a position that approximates a patient lying in bed.

In addition to the aforementioned benefits, some individuals may wish to repeatedly practice the motor skills necessary to perform ISC more often than is appropriate to practice on one's own body. In particular, patients with limited hand dexterity may benefit from repeated practice of these skills after receiving initial training from an occupational therapist (OT) or registered nurse (RN). Further, some individuals with modesty concerns may wish to learn the skill, but will not do so without a model. For example, a patient with religious modesty convictions may not want to practice on their own body where a same-gendered OT or RN is unavailable for a training session. Individuals who currently have an indwelling Foley catheter in place that wish to begin training in advance of planned discontinuation of the Foley catheter may also benefit from training on a model. Patients often struggle with being emotionally ready for practicing ISC on their own bodies. Many other situations are contemplated where a patient may prefer learning on a model as a bridge before learning on their own body.

In operation, the present system for intermittent self-catheterization may be capable of being used (1) at the chair level, situated between the patient's legs while seated in a chair (such as a wheelchair) in an anatomically natural position, (2) on a tabletop or bench, and (3) at the bed level, situated between a patient's legs while lying in bed in an anatomically natural position. To achieve this, the anatomical model portion may be removably connectable to one or more different base portions—e.g., a chair connector base, a tabletop base and/or a bed base—to accommodate the immediate need of the patient, caregiver or healthcare provider. Because the system is customizable in this way, it can provide cost savings to the hospital or rehabilitation center by alleviating the need to purchase separate models for each use case. In some embodiments of the system, the height and angle of the anatomical model portion may be adjustable to provide the most comfortable and personally tailored positioning for the user.

While it is contemplated that both “female” and “male” genitalia models may be used with both the chair and tabletop/bed level base designs, the chair mounted base may more frequently be used by users with “male” genitalia, while the bed/tabletop base may be used by those having “male”or “female”genitalia. Statistically, men make up a larger percentage of the population in need of self-catheterization skills and would be more frequent users.

According to an example (“Example 1”), a self-catheterization training system includes: a base; an anatomical model configured to be releasably connected to the base; and a passage through the anatomical model configured to accept a catheter. The passage has an anterior opening and a posterior opening.

According to another example (“Example 2”) further to Example 1, the anatomical model is one of a model of male genitalia and a model of female genitalia.

According to another example (“Example 3”) further to Example 1, the anatomical model is rotatable with respect to the base.

According to another example (“Example 4”) further to Example 1, the base is a generally U-shaped bracket for accepting a wheelchair cushion.

According to another example (“Example 5”) further to Example 1, the base is generally cone-shaped.

According to another example (“Example 6”) further to Example 1, the system includes a neck releasably connected at an end to the base, and includes one or more laterally-spaced connectors for releasably engaging the anatomical model.

According to an example (“Example 7”), a method of self-catheterization training includes: providing a self-catheterization training system that includes a base, an anatomical model configured to be releasably connected to the base, a passage in the anatomical model configured to accept a catheter and having an anterior opening and a posterior opening; and inserting the catheter into the anterior opening and passing the catheter through the passage to the posterior opening.

According to another example (“Example 8”) further to Example 7, the base is a generally U-shaped bracket for accepting a wheelchair cushion.

According to another example (“Example 9”) further to Example 8, the method includes positioning the self-catheterization training system on a wheelchair such that the anatomical model is proximal to a user's genitalia.

According to another example (“Example 10”) further to Example 7, the anatomical model is rotatable with respect to the base.

According to another example (“Example 11”) further to Example 10, the method includes adjusting an angle of the anatomical model with respect to the base such that the anatomical model is flush against a user's genitalia.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an example of the self-catheterization training system, according to one or more aspects of the disclosure;

FIG. 2 shows a side view of an example of the self-catheterization training system disposed on a seat cushion, according to one or more aspects of the disclosure;

FIG. 3 shows an example of the self-catheterization training system with a table-top base, according to one or more aspects of the disclosure;

FIG. 4 shows an example of the self-catheterization training system with a table-top base, according to one or more aspects of the disclosure;

FIG. 5 shows an example of the self-catheterization training system connected to a table-top base, according to one or more aspects of the disclosure;

FIG. 6 shows an example of the self-catheterization training system disposed on a seat cushion, according to one or more aspects of the disclosure;

FIG. 7 shows an example of the self-catheterization training system with an angled neck, according to one or more aspects of the disclosure;

Corresponding reference characters indicate corresponding elements among the view of the drawings. The headings used in the figures do not limit the scope of the claims.

### DETAILED DESCRIPTION

Various aspects of a self-catheterization training system are described herein. In the following description, reference is made to the accompanying drawings, which form a part hereof, and which show by way of illustration various embodiments in which aspects of the disclosure can be practiced. It is to be understood that other embodiments can be utilized and structural and functional modifications can be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

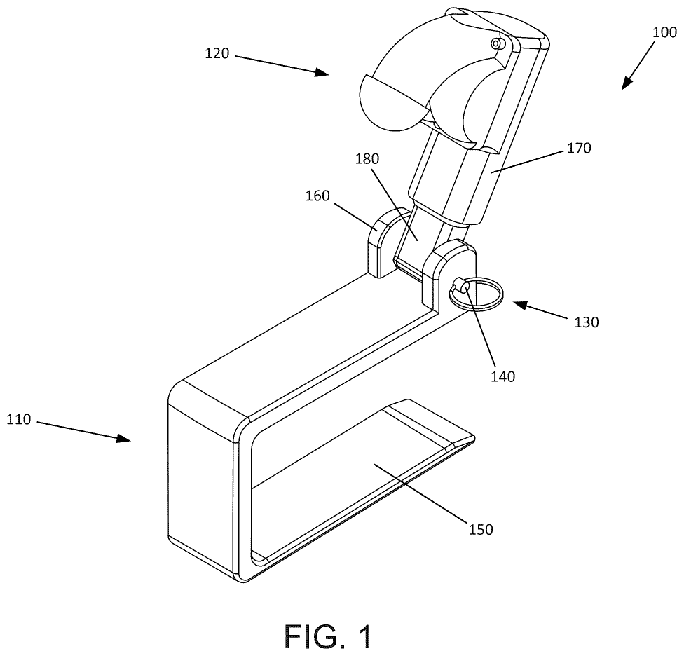

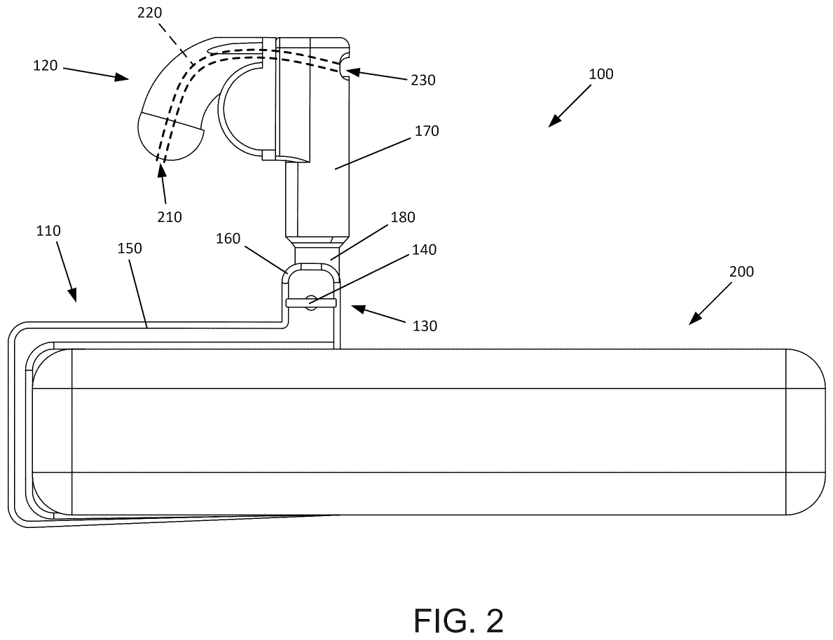

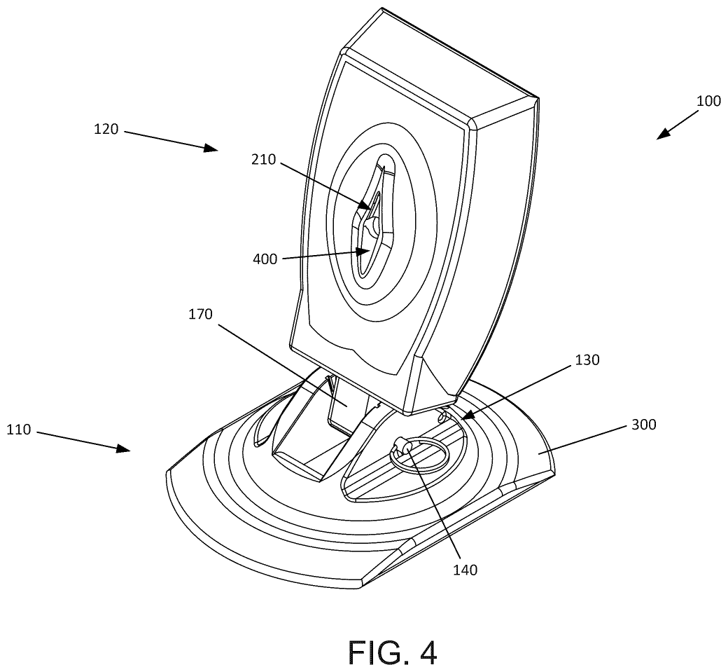

The self-catheterization training system 100, various embodiments of which are shown in the Figures, includes a base portion 110 and an anatomical model portion 120. The anatomical model portion 120 may be provided as either a representation of typical male genitalia as shown in FIGS. 1-3 and 5-7, or as a representation of typical female genitalia as shown in FIG. 4. The anatomical model portions 120 can be, but are not required to be, fully anatomically correct models of genitalia. Rather, the model portions 120 need only reflect sufficient accuracy or detail in anatomy to reliably train a user to perform catheterization. Generally, the model portions 120 should simulate anatomical genitalia sufficiently to allow a user to practice cleansing external genitalia, positioning/manipulating external genitalia for catheterization (including manipulation of the flaccid penis or spreading and holding the labia to access the urethra), inserting the catheter, advancing the catheter, and removing the catheter. Where appropriate, the anatomical model may include a urethral opening (e.g., an opening 210 shown in FIGS. 2 and 4) and a vaginal opening (e.g., an opening 400 shown in FIG. 4) to simulate the need for the user to discriminate between these openings when catheterizing. The anatomical model portion 120 may be formed of any suitable material that has characteristics to approximately simulate real human tissue.

In order to provide self-catheterization training, the anatomical model portion 120 may also include a urethral opening 210 and passage 220 through the anatomical model portion 120 that is configured to accept a catheter or tube therein. The passage 220 defines an anterior opening 210 (such as the urethral opening, and in some configurations, the vaginal opening) and a posterior opening 230 as shown in FIG. 2. The urethral opening 210 and passage 220 may be sized to accommodate a 12 or 14 french intermittent catheter. In some embodiments, the system 100 may further include a bladder or other vessel (not shown) capable of holding a liquid in fluid communication with the urethra passage 220. The bladder may allow a user to learn how far to insert the catheter or tube. Alternatively, the system 100 may be provided without a bladder, or the bladder may be removable, in order to allow the anatomical model portion to be positioned as close to a user's body as possible. In this example, the urethral passage 220 may be oriented such that the tip of the catheter will advance out the top of the model 120 to be visible to the user, so that they know they have advanced it far enough.

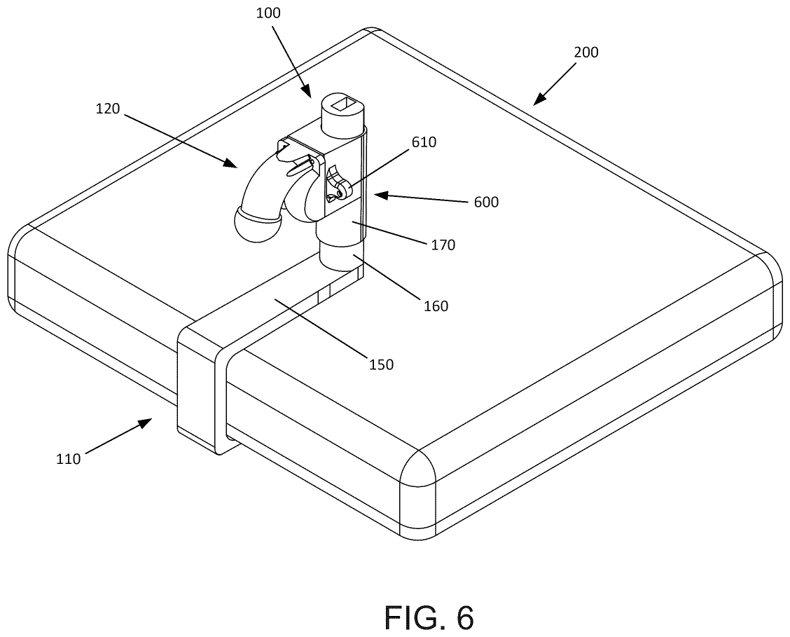

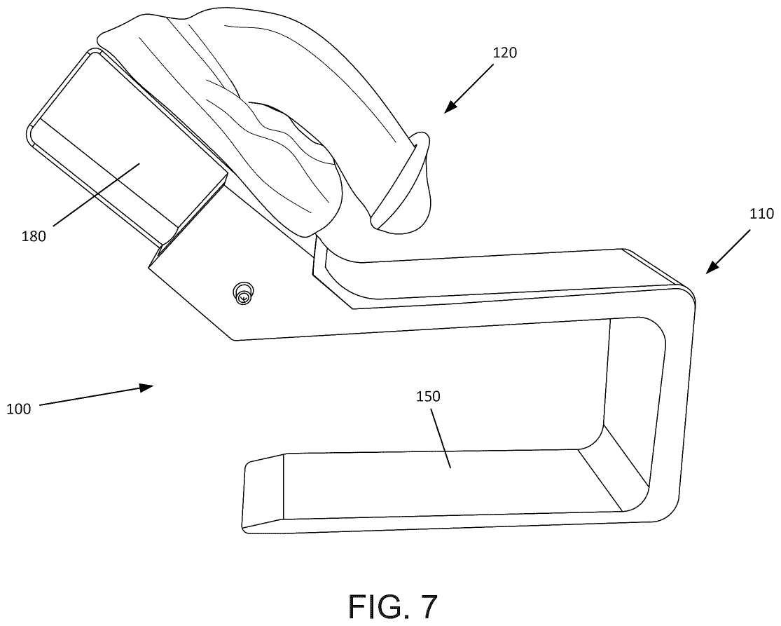

The anatomical model portion 120 of the system 100 may be releasably attached or connected to the base portion 110 to allow interchangeability of the anatomical model (e.g., female or male) or of the base portion 110. For example, the system 100 may include, in one embodiment, a base portion 110 configured to releasably attach to the seat of a wheelchair, a base portion 110 configured to be utilized bedside in a prone or seated position, and a base portion 110 configured to be used on a tabletop. A surface 200 as shown in FIGS. 2 and 6 may represent any one or more of the seat (e.g., of a wheelchair), bed or table. The base portion 110 may be formed of any suitable durable material such that it would not require regular replacement. Further, the anatomical model portion(s) 120 may be easily swapped in or out so that if they become damaged, or additional anatomical model portions 120 are desired, they can be acquired without needing to replace the entire system 100. The anatomical model portion 120 may be releasably attached to the base portion 110 via a hinge portion 130. The hinge portion 130 may include a pin 140 for easy attachment and removal while facilitating a degree of rotational freedom for the anatomical model portion 120. In some examples, such as the embodiments shown in FIGS. 6 and 7, the anatomical model portion 120 may be releasably attached to the base portion 110 via a height adjuster 600 for easy attachment and removal while facilitating a degree of height adjustability for the anatomical model portion 120.

As shown in FIGS. 1 and 2, the base portion 110 may be provided as a generally U-shaped bracket 150 that can be slid on to a surface 200 such as the seat or seat cushion of a wheelchair or regular chair. The opening of the bracket 150 may be sized such that it fits snugly onto a standard wheelchair cushion to securely hold the system 100 onto the wheelchair without more. The bracket 150 may additionally include a clamp or other mechanism (not shown) for securing the bracket to the surface. A connector 160, positioned on the upper arm of the bracket 150, is configured to releasably accept the anatomical model portion 120. In one embodiment, the connector 160 is provided as a yoke, each tine of the yoke including a co-axial hole for accepting a pin 140 therethrough. The anatomical model portion 120 may include a post 170 with a hole therethrough, configured to be positioned and held within the yoke with the pin 140. Other embodiments for mechanically connecting the anatomical model portion 120 to the base portion 110 are contemplated.

The anatomical model portion 120 may be rotatable with respect to the base portion 110. In one embodiment, the anatomical model portion 120 is rotatable within the yoke about the axis of the pin 140. The range of motion may be unlimited, or the elements may be designed to provide for set angles of rotation, for example, vertical, +15 degrees and −15 degrees. This feature allows the angular position of the anatomical model 120 to be adjusted for the user's comfort, or to best model the orientation of the user's own anatomy for training purposes. Alternatively, as shown in FIG. 7, the angle of the anatomical model portion 120 may be fixed with respect to the base portion 110, for example at 15 degrees towards the user. According to some examples, a neck 180 is releasably connected at an end of the base portion 110 and includes one or more laterally-spaced connectors for releasably engaging the anatomical model portion 120. In some embodiments, the neck 180 of the base portion 110 is angled. In further embodiments, the vertical position of the anatomical model portion 120 may also be adjustable with respect to the base portion 110. For example, the tines of the yoke may extend vertically and include one or more additional through holes, thereby allowing a user to customize the height of the anatomical model portion 120 as part of the height adjuster 600.

In operation, a user seated in a wheelchair or their caregiver would slide the U-shaped bracket 150 onto the seat cushion between the user's legs. The user or the caregiver could adjust the lateral or longitudinal position of the system 100 by moving the U-shaped bracket 150 on the seat cushion of the wheelchair and the height and angle of the anatomical model portion 120 with respect to the base portion 110 to provide the best comfort and to most accurately mirror the position of the user's own genitalia. The user may train or practice catheterization by passing a catheter or tube into the urethra opening 210 and through the passage 220 of the anatomical model portion 120. With the system 100, the user may practice catheterization as many times as they desire, without physical or emotional discomfort or risking any bodily harm or infection.

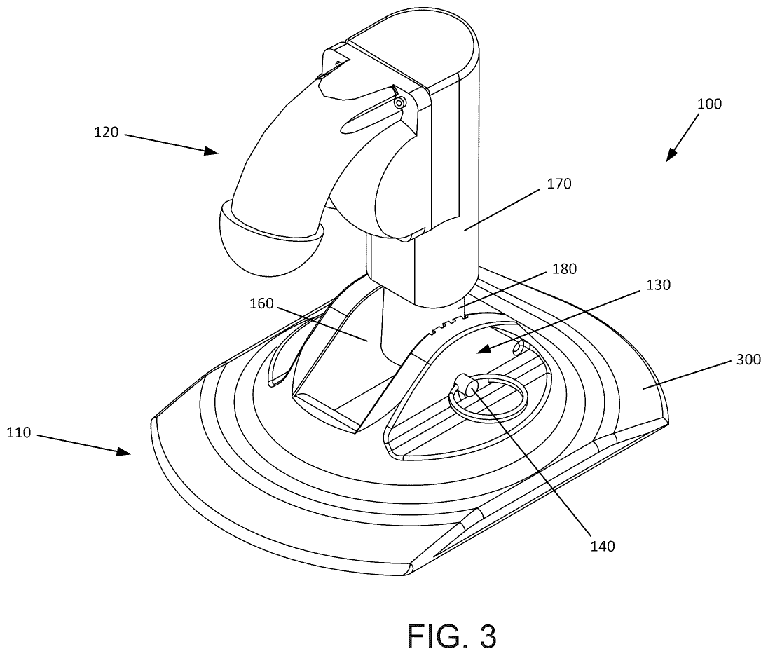

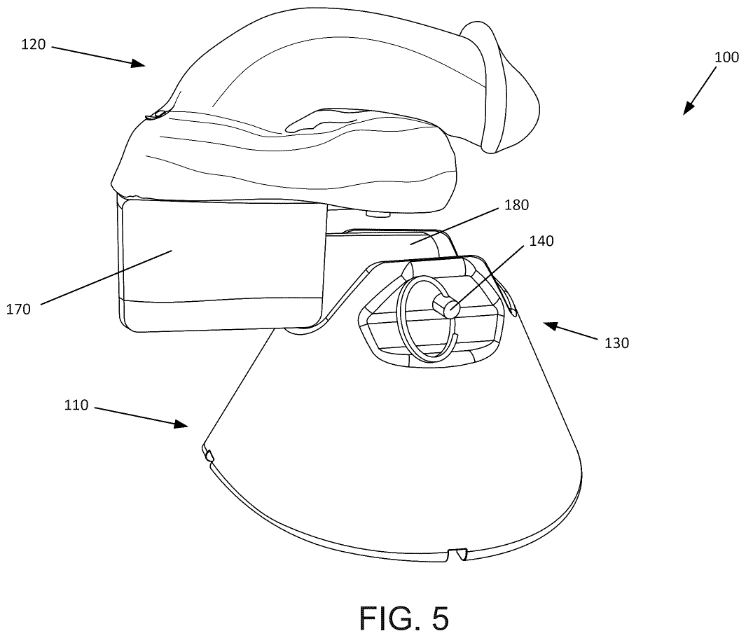

FIGS. 3 and 4 illustrate the system 100 with the anatomical model portion 120, male and female respectively, mounted to a base portion 110 capable of being used prone or seated in a bed, or on a tabletop. The base portion 110 includes a yoke-style connector portion 160, similar to the wheelchair mountable embodiment described above. For added stability, the base portion 110 may include one or more flanges 300. If being used bedside, the user would position the base portion 110 between their thighs, close to their own genitalia. Positional or orientation adjustments to the system 100 may be made as described above. FIG. 5 illustrates an alternate embodiment of the tabletop and bedside system, where the base portion 110 is cone-shaped.

An additional embodiment of the wheelchair mountable system 100 is illustrated in FIG. 6. In this embodiment, the height adjuster 600 may include the connector 160 on the base portion 110 which may include a spring-loaded locking pin 610 configured to be received in one or more openings provided on the post 170 of the anatomical model portion 120. The post 170 may be provided with a number of openings in vertical alignment to allow a user to set the preferred height of the anatomical model portion 120 with respect to the base portion 110. This same connector mechanism may also be implemented with a base portion 110 for tabletop and/or at bed level use. Either male or female anatomical model portions 120 may be affixed to the base portion 110.

A further embodiment of a self-catheterization training system 100 is illustrated in FIG. 7. In this embodiment, the base portion 110 includes a wheelchair attachment (e.g., the bracket 150) and a neck 180. The neck 180 is positioned at a set angle with respect to the wheelchair attachment or the bracket 150. In some examples, the neck 180 is angled at approximately 45 degrees off of the vertical axis of the system 100, or at approximately 135 degrees from the upper arm of the wheelchair attachment or the bracket 150. Other angles are contemplated. This configuration angles the attached anatomical model portion 120 towards the body of a user, which may more accurately reflect the user's physiology.

The self-catheterization training may involve a method or procedure that includes the following steps: (1) providing a user with the self-catheterization training system as disclosed herein, and (2) having the user insert a catheter into the anterior opening and passing the catheter through the passage to the posterior opening. In some examples, the method or procedure may further include a step of having the user position the self-catheterization training system on a wheelchair such that the anatomical model is proximal to the user's genitalia. Alternatively or additionally, in some examples, the method or procedure may further include a step of having the user adjust an angle of the anatomical model with respect to the base such that the anatomical model is flush against the user's genitalia. In some examples, a family member or caregiver may perform one or more of the aforementioned steps as part of the training for catheterizing a patient.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive.

What is claimed is:

1. A self-catheterization training system comprising:
a base;
an anatomical model configured to be releasably connected to the base; and
a passage through the anatomical model configured to accept a catheter, the passage having an anterior opening and a posterior opening.

2. The self-catheterization training system of claim 1, wherein the anatomical model is one of a model of male genitalia and a model of female genitalia.

3. The self-catheterization training system of claim 1, wherein the anatomical model is rotatable with respect to the base.

4. The self-catheterization training system of claim 1, wherein the base is a generally U-shaped bracket for accepting a wheelchair cushion.

5. The self-catheterization training system of claim 1, wherein the base is generally cone-shaped.

6. The self-catheterization training system of claim 1, further comprising a neck releasably connected at an end to the base, and including one or more laterally-spaced connectors for releasably engaging the anatomical model.

7. A method of self-catheterization training, comprising:
providing a self-catheterization training system including:
a base;
an anatomical model configured to be releasably connected to the base; and
a passage in the anatomical model configured to accept a catheter and having an anterior opening and a posterior opening; and
inserting the catheter into the anterior opening and passing the catheter through the passage to the posterior opening.

8. The method of self-catheterization training of claim 7, wherein the base is a generally U-shaped bracket for accepting a wheelchair cushion.

9. The method of self-catheterization training of claim 8, further comprising:
positioning the self-catheterization training system on a wheelchair such that the anatomical model is proximal to a user's genitalia.

10. The method of self-catheterization training of claim 7, wherein the anatomical model is rotatable with respect to the base.

11. The method of self-catheterization training of claim 10, further comprising:
adjusting an angle of the anatomical model with respect to the base such that the anatomical model is flush against a user's genitalia.
